(19) United States
(12) Patent Application Publication
(10) Pub. No.: US 2014/0024355 A1
(43) Pub. Date: Jan. 23, 2014

(54) ELECTRONIC DEVICE CAPABLE OF CONTROLLING FUNCTIONALITY DEPENDING ON LOCATION

(71) Applicant: HON HAI PRECISION INDUSTRY CO., LTD., New Taipei (TW)

(72) Inventors: TIEN-PING LIU, New Taipei (TW); YUAN-FU HUANG, New Taipei (TW)

(73) Assignee: HON HAI PRECISION INDUSTRY CO., LTD., New Taipei (TW)

(21) Appl. No.: 13/688,762

(22) Filed: Nov. 29, 2012

(30) Foreign Application Priority Data
Jul. 19, 2012 (TW) 101126044

(51) Int. Cl. H04W 4/02

(52) U.S. Cl. CPC H04W 4/02
USPC 455/418

(57) ABSTRACT

A portable communication device contains a processor and a storage unit configured to store a number of applications executable by the processor. The communication device communicates with a server and further includes a receiver. The processor can determine whether one of applications belongs to a restricted category when an input unit receives a user input to start any application. The processor can obtain a current location of the portable communication device from the positioning unit, set up a connection with the server, and send a request including the current location to the server. The processor can determine whether the one of the applications are allowed to run in the current location according to a feedback from the server, and start the application if the application is allowed to run in the current location.

### BACKGROUND

1. Technical Field

The present disclosure relates to portable communication devices, and particularly to a portable communication device capable of controlling functionality depending on location.

2. Description of Related Art

Most mobile phones have a digital camera and/or camcorder to record still or video pictures. The ability of users to easily record photographs and/or video on handheld devices presents a security challenge for businesses, corporate facilities, or other locations where picture taking is strictly prohibited or otherwise limited. These types of locations may include museums, factories, government facilities, or office buildings. For many of these locations, the security risk is that portable device users can easily copy and misappropriate trade secret or other corporate proprietary information. Therefore, what is needed is an electronic device to resolve the problems mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic block diagram of one embodiment of an electronic device.

FIG. 2 is a schematic diagram showing applications stored in a storage unit of the electronic device of FIG. 1.

### DETAILED DESCRIPTION

Embodiments of the present disclosure will be described with reference to the accompanying drawings.

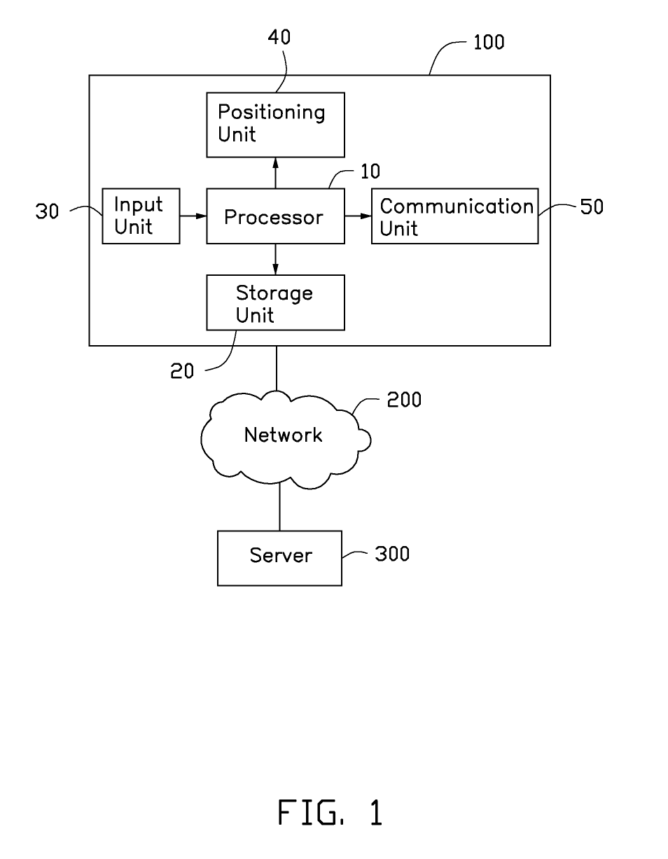

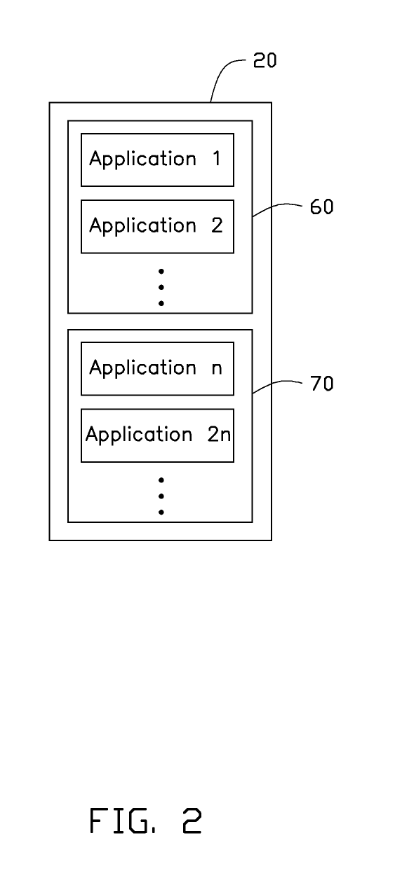

Referring to FIGS. 1 and 2, a portable communicating device 100 includes a processor 10, a storage unit 20, an input unit 30, a positioning unit 40, and a communication unit 50. The communication device 100 can communicate with a server 300 via a network 200.

The storage unit 20 stores a number of applications that are executable by the processor 10. In the embodiment, the applications are classified into two categories: a general category 60 and a restricted category 70 according to a rule provided by an organization (e.g., a company). Applications in the restricted category 70 are prohibited from running in certain locations, while applications in the general category 60 have no such limitations. For example, when the communication device 100 is a cellular phone, a camera application may be classified into the restricted category 70, and a phone call application may be classified into the general category 60. As a result, a user cannot start the camera application in the preset locations (e.g., a laboratory), but can make a phone call by starting the phone call application.

The input unit 30 receives a user input. The positioning unit 40 is normally disabled for saving power, and can determine a geographic location of the portable communication device 100 when enabled. In one embodiment, the positioning unit 40 can receive signals from global positioning system (GPS) satellites and determine a geographic location of the portable communication device 100 according to the received signals. The communication unit 50 can communicate with the server 300 via the network 200.

In one embodiment, when the input unit 30 receives a user input to start an application, the processor 10 determines whether the application belongs to the restricted category 70. If so, the processor 10 enables the positioning unit 40 and obtains the current location of the communicating device 100 from the positioning unit 40. The processor 10 then sets up a connection with the server 300 via the network 200, and sends a request including the current location of the communicating device 100 to the server 300. The processor 10 determines whether the application is allowed to run in the current location according to a feedback from the server 300. If so, the processor 10 starts the application. Otherwise, the processor 10 ignores the user input to start the application.

In one embodiment, the feedback from the server 300 includes a list showing all the applications that are allowed to run in the current location. In other embodiments, the request sent to the server 300 may include the application that the user wants to start, and the feedback from the server 300 may include a list showing all the locations where the application is allowed to run. In any one of the locations, the processor 10 starts the application upon receiving the feedback from the server 300.

In one embodiment, the processor 10 monitors the currently running applications and disables the positioning unit 40 and cuts off the connection between the communication device 100 and the server 300 if none of the currently running applications belong to the restricted category 70. If the currently running applications belong to the restricted category 70, the processor 10 maintains the functioning of the positioning unit 40 and the connection between the communication device 100 and the server 300. As a result, the processor 10 monitors whether the current location changes. When the current location changes, the processor 10 repeats the above-described process to determine whether the currently running applications is allowed to run in the changed current location. When there are one or more currently running applications which are not allowed to run in the changed current location, the processor 10 terminates the running of the one or more currently applications.

While various embodiments have been described and illustrated, the disclosure is not to be construed as being limited thereto. Various modifications can be made to the embodiments by those skilled in the art without departing from the true spirit and scope of the present disclosure as defined by the appended claims.

1. A portable communication device comprising:
a processor;
an input unit configured to receive a user input;
a storage unit configured to store a plurality of applications executable by the processor;
a communication unit configured to communicate with a server;
a positioning unit configured to determine a geographic location of the portable communication device and being normally disabled;
wherein the processor is operable to:
determine whether one of the plurality of applications belongs to a restricted category when the input unit receives a user input to start the one of the plurality of applications;
enable the positioning unit and obtain a current location of the portable communication device from the positioning unit if the one of the plurality of applications belongs to the restricted category;
set up a connection with the server by the communication unit and send a request including the current location to the server;
determine whether the one of the plurality of applications is allowed to run in the current location according to a feedback from the server, wherein the feedback comprises a list showing all the locations where the one of the plurality of application is allowed to run; and
start the one of the plurality of applications if the one of the plurality of applications is allowed to run in the current location.

2. The portable communication device according to claim 1, wherein the processor is operable to monitor one or more of the plurality of applications that are currently running, and disable the positioning unit and cut off the connection if the one or more of the plurality of applications do not belong to the restricted category.

3. The portable communication device according to claim 1, wherein the processor is operable to monitor one or more of the plurality of applications that are currently running, maintain the connection and the positioning unit to be enabled, thereby to monitor whether the one or more of the plurality of applications are allowed to run in the current location.

4. The portable communication device according to claim 1, wherein the feedback comprises a list comprising all of the plurality of applications allowed to run in the current location.

5. The portable communication device according to claim 1, wherein the positioning unit is operable to communicate with global positioning system satellites to determine the geographic location of the portable communication device.
